(19) United States
(12) Patent Application Publication
(10) Pub. No.: US 2026/0214376 A1
(43) Pub. Date: Jul. 23, 2026

(54) IN-VEHICLE SUBWOOFER

(71) Applicant: GUANGZHOU OAKTREE TRADING CO., LTD., GUANGZHOU (CN)

(72) Inventor: Fengjun YAN, Guangzhou (CN)

(21) Appl. No.: 19/135,582

(22) PCT Filed: Aug. 5, 2024
(86) PCT No.: PCT/CN2024/109804

§ 371 Date: Jun. 4, 2025

(51) Int. Cl. H04R 1/28; H04R 1/02; H04R 9/06

(52) U.S. Cl. CPC H04R 1/2834; H04R 1/021; H04R 1/288; H04R 9/06; H04R 2499/13

(57) ABSTRACT

The present application relates to an in-vehicle subwoofer, which includes: a loudspeaker; a magnetic control assembly provided in the loudspeaker; a vibration sounding assembly, the vibration sounding assembly generates vibration and produces sound under an action of a magnetic field of the magnetic control assembly; a balancer provided in the loudspeaker, the balancer includes a recessed cavity portion and an edge plate, the edge plate is a flat plate, an opening is provided on a middle portion of the edge plate, the edge plate is sleeved on an open end of the recessed cavity portion, the opening of the edge plate is connected to an outer side surface of the recessed cavity portion; a gap is provided between a bottom surface of the recessed cavity portion and the loudspeaker to form a sound cavity.

### CROSS-REFERENCE TO RELATED APPLICATION

This application is a national application of PCT/CN2024/109804 filed on Aug. 5, 2024. The contents of all of which are incorporated herein by reference.

### FIELD OF TECHNOLOGY

The present application relates to the technical field of loudspeakers, and in particular to an in-vehicle subwoofer.

### BACKGROUND

An in-vehicle subwoofer is an important component of a vehicle audio system. A subwoofer, also called a bass loudspeaker, is capable for producing relatively low-frequency sounds (typically in a 20-200 Hz range), which may make music quality more passionate and impactful. Therefore, in-vehicle subwoofers have become an important choice for many people when upgrading automotive loudspeakers.

The subwoofer mainly includes an auxiliary control unit and a speaker unit, in which, the auxiliary control unit provides an installation space for the speaker unit, and a sound production mainly relies on the speaker unit. The speaker unit usually includes a magnetic control assembly and a vibration sounding assembly. The magnetic control assembly is configured to provide a magnetic field. When an audio current flows in, the vibration sounding assembly vibrates to cause an air vibration, thus producing sound. This process of transforming electrical energy into acoustical energy enables the subwoofer to produce powerful and deep bass performance.

However, existing in-vehicle speakers often exhibit subpar bass performance when playing bass sounds.

### SUMMARY

Based on this, a purpose of the present application is to overcome shortcomings and deficiencies in the prior art and provide an in-vehicle subwoofer.

An in-vehicle subwoofer, including:
a loudspeaker;
a magnetic control assembly provided in the loudspeaker;
a vibration sounding assembly, wherein, the vibration sounding assembly generates vibration and produces sound under an action of a magnetic field of the magnetic control assembly;
a balancer provided in the loudspeaker, wherein, the balancer includes a recessed cavity portion and an edge plate, the edge plate is a flat plate, an opening is provided in a middle portion of the edge plate, the edge plate is sleeved on an open end of the recessed cavity portion, the opening of the edge plate is connected to an outer side surface of the recessed cavity portion; a gap is provided between a bottom surface of the recessed cavity portion and the loudspeaker to form a sound cavity.

Compared with the prior art, the present application adds the balancer in the loudspeaker, the balancer has the recessed cavity portion, the sound cavity is formed between the balancer and the loudspeaker, expanding an airflow space and making bass dynamic more complete, thereby achieving a looser and fuller low-frequency performance. Simultaneously, a vibration sounding unit drives the balancer to vibrate, enabling the balancer to reflect sound, which contributes to an up and down balance of bass movement.

### BRIEF DESCRIPTION

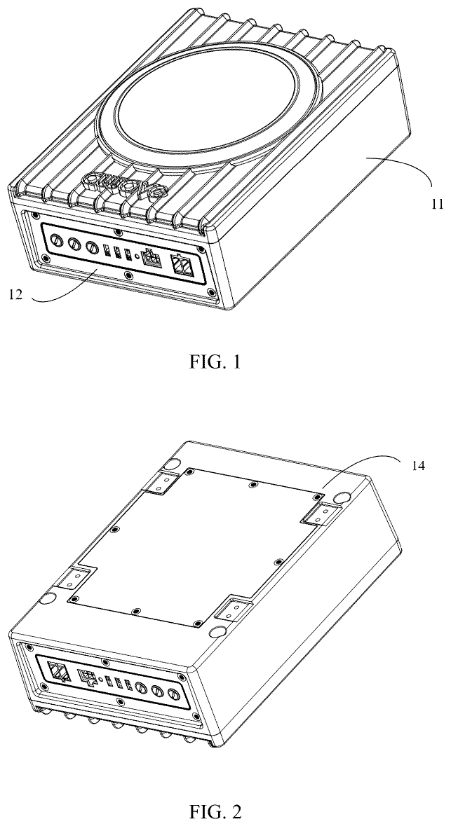

FIG. 1 is a front view of an in-vehicle subwoofer in Embodiment 1 of the present application;

FIG. 2 is a schematic diagram of a structure of a bottom portion of the in-vehicle subwoofer in Embodiment 1 of the present application;

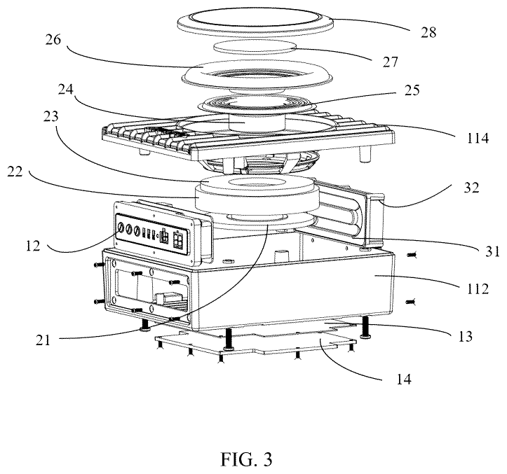

FIG. 3 is an exploded view of the in-vehicle subwoofer in Embodiment 1 of the present application;

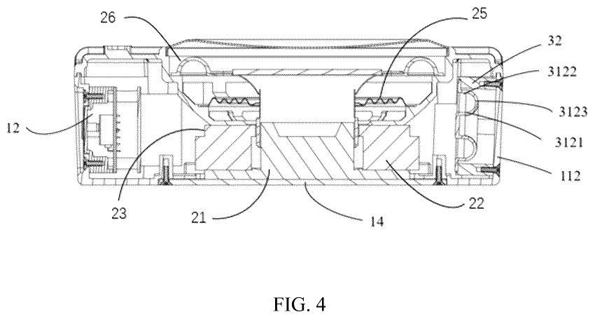

FIG. 4 is a schematic diagram of a structure of a cross-section of the in-vehicle subwoofer in Embodiment 1 of the present application;

FIG. 5 is a front view of a balancer of an in-vehicle subwoofer in one embodiment of the present application;

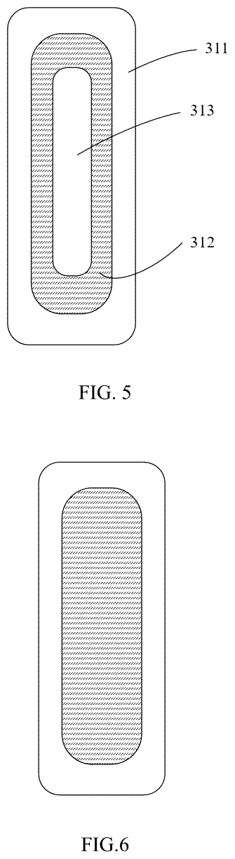

FIG. 6 is a front view of a balancer of an in-vehicle subwoofer in another embodiment of the present application;

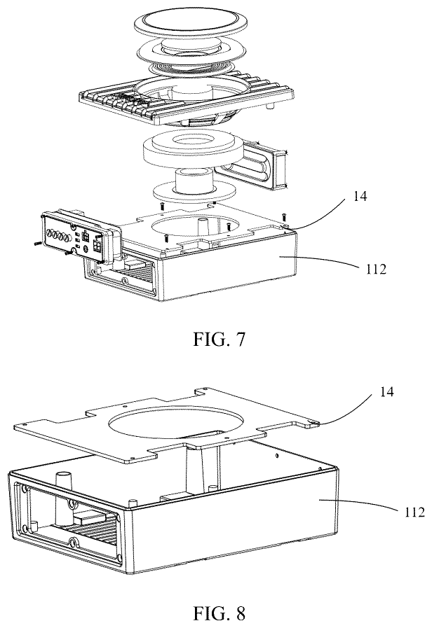

FIG. 7 is an exploded view of a bottom plate of an in-vehicle subwoofer in one embodiment of the present application;

FIG. 8 is a schematic diagram of a structure of a bottom plate of an in-vehicle subwoofer in one embodiment of the present application;

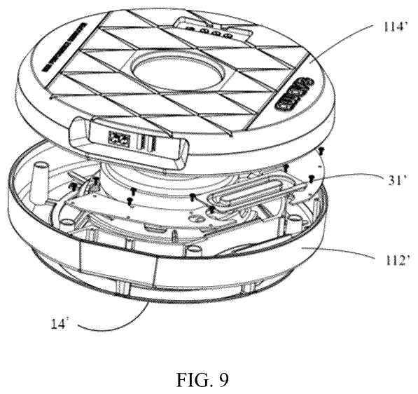

FIG. 9 is a schematic diagram of a structure of an in-vehicle subwoofer in Embodiment 2 of the present application;

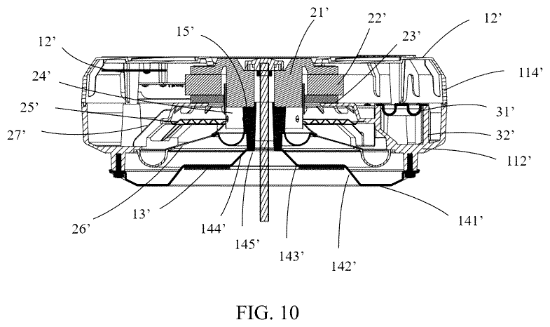

FIG. 10 is a schematic diagram of a structure of a cross-section of the in-vehicle subwoofer in Embodiment 2 of the present application;

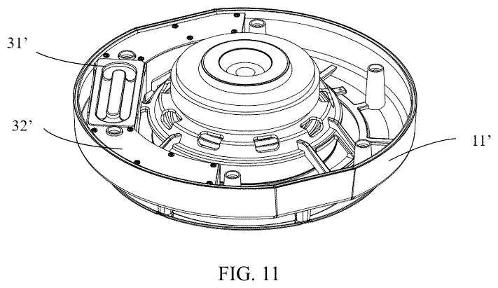

FIG. 11 is a schematic diagram of the in-vehicle subwoofer in Embodiment 2 of the present application without a cover.

### DETAILED DESCRIPTION

In order to make the above objects, features and advantages of the present application more clearly understood, specific embodiments of the present application will be described in detail below with reference to the accompanying drawings. In the following description, numerous specific details are set forth in order to provide a thorough understanding of the present application. However, the present application can be implemented in many other ways different from those described herein, and those skilled in the art can make similar improvements without departing from the connotation of the present application, therefore, the present application is not limited by the specific embodiments disclosed below.

To enhance bass performance, the present application conducted observation and analysis of a sounding state of in-vehicle subwoofers. It was discovered that in-vehicle subwoofers require an sound cavity with a certain volume to displace substantial air molecules per unit time, thereby generating powerful bass. However, in-vehicle subwoofers are typically installed under seats or on spare tires, spaces are relatively small. As a result, bass airflow rapidly impacts a loud speaker and reflects upward during movement. This leads to an incomplete bass diving, affecting bass quality.

Base on this, a balancer is added in an in-vehicle subwoofer of the present application to expand an airflow space, thereby achieving a purpose of enhancing low-frequency performance. Furthermore, a bottom cover made of a different material from the loudspeaker is installed inside or outside a bottom of the loudspeaker. This not only alters an overall center of gravity, but also improves damping and rigidity of the loud speaker, effectively reducing acoustic distortion and minimizing low-frequency resonance phenomena of the loudspeaker, thus elevating bass quality.

The following describes the technical solutions in detail by using specific embodiments.

### Embodiment 1

Please refer to FIGS. 1-4. An in-vehicle subwoofer of Embodiment 1 includes an auxiliary control unit, a speaker unit and a balancing unit. Among them, the auxiliary control unit provides an installation space. The speaker unit and the balancing unit are provided in the installation space of the auxiliary control unit.

The auxiliary control unit includes a loudspeaker 11, a controller 12, an EVA(Ethylene Vinyl Acetate) plate 13 and a bottom cover 14. The loudspeaker 11 is a metal heat-dissipation box, which includes a metal box body 112 and a metal cover body 114 covering on the box body 112. Among them, the box body 112 in this embodiment is of an integrated cuboid structure made of aluminum. The controller 12 includes a control circuit provided in the box body 112 and a control panel electrically connected to the control circuit. The control panel is embedded in and protrudes from a side surface of the box body 112. The EVA plate 13 covers on an outer side bottom surface of a bottom portion of the box body 112. The bottom cover 14 covers on the EVA plate 14. In this embodiment, the bottom cover 14 is an iron plate. The EVA plate 13 is provided between the box body 112 and the bottom cover 14 to provide sealing and cushioning functions. Both the EVA plate 13 and the bottom cover 14 are provided with six perforations and are fixedly connected to the bottom portion of the box body 112 through screws.

The speaker unit includes a magnetic control assembly and a vibration sounding assembly. The magnetic control assembly includes a T-yoke 21, a magnetic steel 22 and a washer 23. The vibration sounding assembly includes an voice coil 24, a damper 25, a cone 26, a dust cover 27 and a speaker mesh 28. Among them, the magnetic control assembly is provided in the installation space of the auxiliary control unit. The vibration sounding assembly is fixedly connected to the auxiliary control unit. The magnetic control assembly provides a magnetic field. After an audio current flows in, the vibration sounding assembly generates vibration to induce air vibration, thus producing sound.

In the magnetic control assembly, the T-yoke 21 includes a disk and a column. A recessed portion is provided on an inner bottom surface of the box body 112. The disk is installed in the recessed portion. The column is fixed on the disk. The magnetic steel 22 is of an annular shape. The magnetic steel 22 is sleeved on the column of the T-yoke 21. A gap is provided between the column and the magnetic steel 22 to form a uniform magnetic flux loop. Also, the washer 23 is of an annular shape. The washer 23 is provided on the magnetic steel 22 and is configured as a magnetic conductor. The washer 23 and the magnetic steel 22 form a magnetic flux loop. Also, a gap is provided between the washer 23 and the column.

In the vibration sounding assembly, a part of the voice coil 24 is embedded in the gap between the washer 23 and the column and the gap between the magnetic steel 22 and the column, and is able to move up and down along the column. The damper 25 is of an annular shape. The damper 25 is sleeved on an exposed end portion of the voice coil 24 to maintain the voice coil 24 in a correct position and perform stable reciprocating motion along an axial direction. The cone 26 includes a surround and a diaphragm. The surround is of an annular structure formed by an arc-shaped bent edge, and the diaphragm is of a horn-shaped structure. One end of the diaphragm is connected to an inner side edge of the surround, the other end of the diaphragm passes through a perforation of the cover body 114 and is able to contact in vibrational with a top end of the voice coil 24. An outer edge of the surround is fixed on an upper surface of the cover body 114. The dust cover 27 is covered on an opening formed by the diaphragm, which prevents dust and debris from entering a magnetic loop system, thereby avoiding degradation in sound quality of automotive speakers. The speaker mesh 28 is covered on an opening of the cover body 114, not only isolating dust but also transmitting and filtering sound.

The balancing unit includes a balancer 31 and a supporting assembly 32. Please refer to FIG. 5. The balancer 31 includes an edge plate 311, a recessed cavity portion 312 and a middle plate 313. The edge plate 311 is a flat plate. An elliptical opening is provided on a middle portion of the edge plate 311. The recess cavity portion 312 includes an inner side surface 3121 in an annular shape, an outer side surface 3122 in an annular shape that surrounds and faces the inner side surface 3121, and a bottom surface 3123 that connects the inner side surface 3121 and the outer side surface 3122 to form an annular groove. In this embodiment, the bottom surface 3123 of the recessed cavity portion 312 is curved, in other embodiments, is square, or other shapes, and is not limited thereto in the present application. The middle plate 313 is an elliptical plate. The middle plate 313 is covered on an edge of the inner side surface 3121 of an open end of the recessed cavity portion 312. In this embodiment, the supporting assembly 32 is a cuboid structure with an opening on both ends, which is formed by a plurality of sealing plates. One end of the supporting assembly 32 is fixedly connected to an inner side surface of the box body 112, the other end of the supporting assembly 32 is fixedly connected to the edge plate 311 of the balancer 31, making the bottom surface 3123 of the recessed cavity portion 312 of the balancer 31, the edge plate 311 and the box body 112 form a sound cavity, as shown in FIG. 4.

In the in-vehicle subwoofer, the magnetic control assembly generates a constant magnetic field with unchanging magnitude and direction. When the controller 12 inputs current into the voice coil 24, a coil of the voice coil 24 generates a magnetic field. Due to variations in an audio current, the magnetic field generated by the voice coil 24 continuously varies in magnitude and direction. Since the voice coil 24 is partially embedded in the magnetic control assembly, a varying magnetic field generated by the voice coil 24 interacts with a constant magnetic field of the magnetic control assembly. This causes the voice coil 24 to move up and down within an annular gap of the magnetic control assembly, thereby driving the diaphragm to vibrate and produce sound.

Compared with the prior art, the present application adds the balancer in the loudspeaker. The balancer is provided with the recessed cavity portion. The sound cavity is formed between the balancer and the loudspeaker, which increases an airflow space and allows bass dynamics to be more complete, thereby achieving a looser and fuller low-frequency performance. Meanwhile, the vibration sounding unit drives the balancer to vibrate, enabling the balancer to reflect sound and contributing to an up and down balance of bass motion. Additionally, by adding one bottom plate made of a different material from the loudspeaker on an outer side of the bottom portion of the loudspeaker, an overall center of gravity is changed, and damping and rigidity of the loudspeaker are enhanced. This effectively reduces acoustic distortion and minimizes low-frequency resonance, thus improving bass quality.

There are various implementation manners in the present application. For example, the box body of the loudspeaker may be made of iron or stainless steel, and the bottom plate is made of stainless steel plate or other metallic materials, provided that material of the box body of the loudspeaker differs from material of the bottom plate. Additionally, in other embodiment, the groove of the balancer is other structural configurations. As shown in FIG. 6, the balancer only includes the edge plate and the recessed cavity portion, the recessed cavity portion includes an elliptical side surface and a bottom surface connected to a bottom portion of the side surface. The edge plate is sleeved on the open end of the recessed cavity portion. The opening of the edge plate is connected to the side surface of the recessed cavity portion. As shown in FIGS. 7-8, the bottom plate 14 may be provided on an inner side surface of the bottom portion of the box body 112 of the loudspeaker 11. This also change an overall center of the loudspeaker, improve damping and rigidity of the loudspeaker, This reduces acoustic distortion and minimizes low-frequency resonance phenomena of the loudspeaker, thus improving bass quality.

### Embodiment 2

Please refer to FIGS. 9-11. In an in-vehicle subwoofer of Embodiment 2, an auxiliary control unit includes a loudspeaker 11′, a controller 12′, an EVA plate 13′, a bottom cover 14′and a middle column 15′. The loudspeaker 11′includes a box body 112′and a cover body 114′covered on the box body 112′. Among them, the box body 112′includes a main body portion, a platform portion and a supporting portion. The main body portion is a circular housing, the platform portion is a circular plate having an opening on its middle portion. An outer end portion of the platform portion is fixedly connected to a lower end of the main body portion. The supporting portion is a hollow column. An upper end of the supporting portion is fixedly connected to a bottom surface of the platform portion. The controller 12′includes a control circuit provided in the box body 112′and a control panel electrically connected to the control circuit. The control panel is embedded in and protrudes from an upper surface of an upper cover 114′.

The bottom cover 14′includes a first connecting portion 141′, and first inclined portion 142′, a second connecting portion 143′, a second inclined portion 144′ and a positioning plate 145′. One end of the first connecting portion 141′is connected to a thread located on a lower end of the supporting portion of the box body 112′. A lower end of the first inclined portion 142′is fixedly connected to the other end of the first connecting portion 141′. One end of the second connecting portion 143′is fixedly connected to an upper end of the first inclined portion 142′. A lower end of the second inclined portion 144′is fixedly connected to the other end of the second connecting portion 143. An opening is provided on a middle portion of the positioning plate 145′. An outer end of the positioning plate 145′is fixedly connected to an upper end of the second inclined portion 144′. The EVA plate 13′is fixed on an outer side bottom surface of the second connecting portion 143′of the bottom cover 14′. The middle column 15′has a hollow column structure. A bottom end of the middle column 15′is fixed on the positioning plate 145′of the bottom cover 14′.

The magnetic control assembly includes a T-yoke 21′, a magnetic steel 22′ and a washer 23′. Among them, the T-yoke 21′includes a column that is hollow inside and a disk connected to an upper end of the column. A bottom end of the column of the T-yoke 21′is fixed on an upper end of the middle column 15′. The magnetic steel 22′is an annular shape. The magnetic steel 22′is sleeved on the column of the T-yoke 21′. A gap is provided between the magnetic steel 22′and the column to form a uniform magnetic flux loop. The washer 23′is sleeved on the column of the T-yoke 21′, provided on a lower end of the magnetic steel 22′away from the disk of the T-yoke 21′and is configured as a magnetic conductor. The washer 23′and the magnetic steel 22′form a magnetic flux loop. Also, a gap is provided between the washer 23′and the column.

The vibration sounding assembly includes a voice coil 24′, a damper 25′, a cone 26′and a speaker 27′. Among them, a part of the voice coil 24′is embedded in the gap between the washer 23′and the column and the gap between the magnetic steel 22′and the column, and able to move up and down along the column. The damper 25′is of an annular shape. The damper 25′is sleeved on an exposed end portion of the voice coil 24′to maintain the voice coil 24′in a correct position and perform a stable reciprocating motion along an axial direction. The cone 26′includes a diaphragm and a surround provided on both ends of the diaphragm. The surround is of an annular structure formed by an arc-shaped bent edge. one end of the surround is fixedly connected to the middle column 15′, the other end of the surround is fixedly connected to a bottom surface of the platform portion of the box body 112′. The speaker 27′is covered on the voice coil 24′, the damper 25′and the cone 26′. A lower end of the speaker 27′is fixedly connected to an upper end of the platform portion of the box body 112′.

The balancing unit includes a balancer 31′and a supporting assembly 32′. Among them, a structure of the balancer 31′is as the same as that of Embodiment 1, and will not be described again here. In this embodiment, the supporting assembly 32′ includes a plurality of sealing plates. The plurality of sealing plates and an inner side surface of the box body 112′form a cavity with an upper opening. An edge plate of the balancer 31′is fixed on the upper opening of the cavity, forming a sound cavity between the balancer 31′and the box body 112′.

Technical features of the above embodiments may be combined arbitrarily. For brief description, not all of the possible combinations of the technical features of the above embodiments are described, but it will be appreciated that these possible combinations belong to the scope of the present application once there is no conflict between the technical features.

The above-described embodiments merely represent several embodiments of the present application, and the description thereof is more specific and detailed, but it should not be construed as limiting the scope of the present application. It should be noted that variations and improvements will become apparent to those skilled in the art to which the present application pertains without departing from its spirit and scope. Therefore, the scope of the present application is defined by the appended claims.

1. An in-vehicle subwoofer, comprising:
a loudspeaker;
a magnetic control assembly provided in the loudspeaker;
a vibration sounding assembly, wherein the vibration sounding assembly generates vibration and produces sound under an action of a magnetic field of the magnetic control assembly;
a balancer provided in the loudspeaker, wherein the balancer includes a recessed cavity portion and an edge plate, the edge plate is a flat plate, an opening is provided in a middle portion of the edge plate, the edge plate is sleeved on an open end of the recessed cavity portion, the opening of the edge plate is connected to an outer side surface of the recessed cavity portion; a gap is provided between a bottom surface of the recessed cavity portion and the loudspeaker to form a sound cavity.

2. The in-vehicle subwoofer of claim 1, wherein the recessed cavity portion includes an inner side surface in an annular shape, an outer side surface in an annular shape that surrounds the inner side surface and faces the inner side surface, and a bottom surface connected to the inner side surface and the outer side surface to form an annular groove; the balancer further includes a middle plate, the middle plate is covered on an edge of an inner side surface of the open end of the recessed cavity portion.

3. The in-vehicle subwoofer of claim 1, wherein the bottom surface of the recessed cavity portion is of an arc-shape.

4. The in-vehicle subwoofer of claim 1, wherein a box body of the loudspeaker is of a cuboid structure, the bottom surface of the recessed cavity portion of the balancer and one side of the box body form a sound cavity.

5. The in-vehicle subwoofer of claim 4, further comprising: a bottom plate, wherein the bottom plate is covered on an outer side surface or an inner side surface of a bottom portion of the box body of the loudspeaker;
the loudspeaker is an iron box, and the bottom plate is an aluminum plate or a stainless steel plate; or, the loudspeaker is an aluminum box, and the bottom plate is an iron plate or a stainless steel plate; or, the loudspeaker is a stainless steel box, and the bottom plate is an aluminum plate or an iron plate.

6. The in-vehicle subwoofer of claim 5, further comprising: an EVA plate, wherein the EVA plate is provided between a bottom surface of the box body of the loudspeaker and the bottom plate.

7. The in-vehicle subwoofer of claim 1, wherein the box body of the loudspeaker is in a circular structure, the bottom surface of the recessed cavity portion and an inner surface of the box body form the sound cavity.

8. The in-vehicle subwoofer of claim 7, further comprising: a supporting assembly, wherein the supporting assembly includes a plurality of sealing plates, the plurality of sealing plates and an inner side surface of the box body form a cavity, an opening is provided on a top portion of the cavity, the edge plate of the balancer is fixed on the opening of the cavity.

9. The in-vehicle subwoofer of claim 7, further comprising: a bottom cover, wherein the bottom cover, the box body of the loudspeaker and a cover body of the loudspeaker form an installation space for the magnetic control assembly, the vibration sounding assembly and the balancer;
the box body of the loudspeaker is made of iron, the bottom cover is made of aluminum or stainless steel; or, the box body of the loudspeaker is made of aluminum, the bottom cover is made of iron or stainless steel; or, the box body of the loudspeaker is made of stainless steel, the bottom cover is made of aluminum or iron.
